(19) United States
(12) Patent Application Publication
(10) Pub. No.: US 2017/0059748 A1
(43) Pub. Date: Mar. 2, 2017

(54) Light Diffusing Module

(71) Applicant: American SUN-TEC LLC, Orange, NJ (US)

(72) Inventor: David Chan, Passaic, NJ (US)

(73) Assignee: AMERICAN SUN-TEC LLC, Orange, NJ (US)

(21) Appl. No.: 14/843,742

(22) Filed: Sep. 2, 2015

(51) Int. Cl. G02B 5/02; F21V 7/05; G09F 13/22; G02B 1/11; G09F 13/16; F21V 5/00; F21S 9/03

(52) U.S. Cl. CPC G02B 5/0215; F21V 5/002; F21V 7/05; F21S 9/03; G02B 1/11; G02B 5/0278; G09F 13/16; G09F 13/22; F21W 2111/00

(57) ABSTRACT

Disclosed is a light diffusing panel, a light diffusing module and a traffic sign incorporating the light diffusing module. A front face of the panel has a plurality of linear disruptions, which disruptions redirect the light to emit from the front face of the panel in a broad diffuse emission. The plurality of linear disruptions extends as a series of parallel lines across the front face. A second plurality of linear disruptions extends as a series of parallel lines across the front face, with the first plurality of linear disruptions forming a grid across the front face. The light diffusing module adds to the light diffusing panel, a reflective sheet adjacent to the rear face of the light diffusing panel and light sources along an edge of the light diffusing panel. The traffic sign adds a message panel to the light diffusing module as well as a power supply.

### FIELD OF INVENTION

The present invention is in the field of light diffusing panels and assemblies of light diffusing modules, and the use of light diffusing modules for signs, in particular traffic signs.

### BACKGROUND

Light is electromagnetic energy transmitting with the characteristics of both particles and waves. The intensity of visible light can be modified by a diffuser, as is known in the art.

Light emitting diodes (LEDs) are used in an increasing amount as alternates to other, more traditional, lighting sources, such as incandescent and fluorescent lights. For the same power utilization, LEDs emit far more light than the more traditional lighting sources, and use far less power for the same amount of light. LEDs have a longer operational lifespan, and may be used in environmental conditions that do not permit long use of traditional lighting sources.

LEDs present a number of disadvantages that have prevented them from being adopted as replacements for traditional lighting sources. LEDs are discrete sources of light, producing intense light within the narrow beam of their output, and dim light outside of that beam. This problem is known as the point source problem of LED lighting.

LEDs provide only point source illumination, not uniform planar illumination. It is consequently necessary to somehow distribute the light emitted by one or more LEDs so as to uniformly illuminate a plane. LEDs are often set in a row or array to increase overall light output and attempt to provide a broader beam of light.

It is known to add a diffuser to one or more LEDs to alleviate the point source problem, distributing the point source light to a broader distribution. Prior art diffusers include a frosted or abraded surface, a particulate medium, prisms or lenses on a diffuser panel surface, raised protrusions on a diffuser panel surface, coatings, reflective surfaces and combinations of one or more of the foregoing. Microelectromechanical systems have also been used for diffusing or redirecting LED light sources, primarily in liquid crystal display systems.

Prior art edge lit diffusing panels have provided a variety of surface disruptions to reflect LED light, including frosted or abraded surfaces, dot or circle disruptions, and lines. Prior art diffusing panels have disclosed varying the size and depth of the surface disruptions as a way of providing uniform light intensity over an area.

The present invention has a specific utilization for traffic signs and signaling apparatus. Prior art traffic signs provide a reflective surface allowing for greater visibility of the signs at night or in reduced lighting conditions. However, the reflective surface relies upon an external light source, such as that of an oncoming vehicle or a fixed mounted light, and the visibility of the traffic sign and its reflective surface is dependent upon the brightness and angle of the external light source relative to the desired viewer of the traffic sign. Where a vehicle may not have fully operational forward facing lights, the available light for reflection would be reduced, thereby reducing the effective visibility of the traffic sign.

The invention is specifically designed for use in traffic signs, providing a greater visibility than available by reflecting an external light. Providing an internal illumination for traffic signs will result in greater efficiency and safer conditions for motor vehicle operators and pedestrians alike.

### SUMMARY OF THE INVENTION

The present invention is a light diffusing panel and light diffusing module incorporating the light diffusing panel. The light diffusing panel allows light to enter from distinct light sources, preferably LEDs, at an edge of the panel. A front face of the panel is comprised of a plurality of etched linear disruptions. The plurality of etched linear disruptions extends as a series of parallel lines across the front face. Preferably, a second plurality of etched linear disruptions extends as a series of parallel lines across the front face, perpendicular to the first plurality of etched linear disruptions, forming a grid across the front face. The rear face of the panel is preferably smooth, allowing light to reflect toward the front face. The linear disruptions on the front face increase the redirection of light to emit from the front face of the panel in a broad diffuse emission.

The light diffusing module is comprised of the light diffusing panel, a reflective sheet adjacent to the rear face of the light diffusing panel, and a plurality of light sources along an edge of the light diffusing panel.

The invention is specifically designed for incorporation into traffic signs, providing a traffic sign capable of being visible at greater distances than by mere reflection of oncoming vehicle lights. As a traffic sign, the light diffusing module is placed behind an informative signage or graphic, providing a back lighting effect for the signage and increasing the visibility thereof.

### BRIEF DESCRIPTION OF THE DRAWINGS

FIG. 1 is a front perspective exploded view of the light diffusing panel of the present invention.

FIG. 2 is a front plan view of the light diffusing panel of the present invention.

FIG. 3 is cross-sectional side view along line B-B of FIG. 2.

FIG. 4 is a cross-sectional side view along line A-A of FIG. 2.

FIG. 5 is a front perspective exploded view of a light diffusing module of the present invention.

FIG. 6 is a front plan view of a traffic sign incorporating the light diffusing module of the present invention.

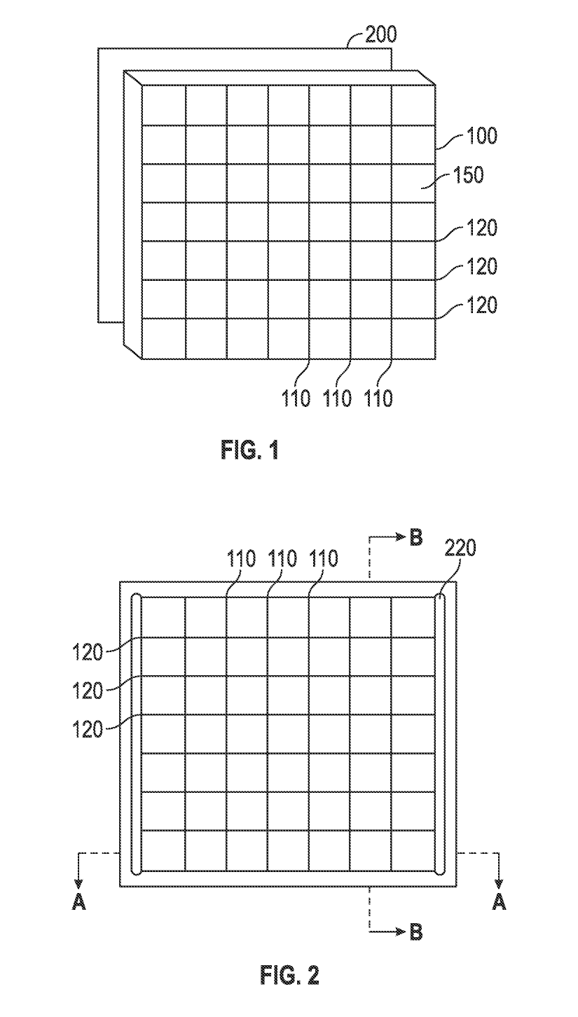

### DETAILED DESCRIPTION OF THE PREFERRED EMBODIMENT

The invention preferably consists of a light diffusing panel 100 formed of a plane of transparent or nearly transparent material. The light diffusing panel 100 has front and rear planar surfaces (101, 102). The front planar surface 101 has a first plurality of linear disruptions 120 extending along its surface. In a preferred embodiment, there is a second plurality of linear disruptions 110 extending perpendicular to the first plurality of linear disruptions 120, forming a grid 150 on the front planar surface 101.

The linear disruptions (110, 120) on the front planar surface 101 are preferably uniform in depth and width. The linear disruptions (110, 120) on the front planar surface 101 are preferably formed by laser etching, which is known to create uniform lines. Linear disruptions (110, 120) are interruptions in the front planar surface 101, which otherwise has a smooth and even surface.

Light diffusing panel 100 is capable of receiving light emanating from a light source, where the light is initially directed at an oblique angle relative to the front planar surface 101. Preferably, the light source generates beams of light directed perpendicular to the front planar surface. At least part of the light entering light diffusing panel 100 will interact with the linear disruptions, causing refraction toward and outward from the front planar surface 101. Other components of the light entering light diffusing panel 100 will reflect off of the interiors of front planar surface 101 and rear planar surface 102, eventually emanating outward through front planar surface 101.

Light diffusing panel 100 may be comprised of glass, acrylic or plastic, or any material capable of allowing light to transmit there through. The thickness of light diffusing panel 100 may vary, but is preferably wider than the width of a light source used with the light diffusing panel to ensure efficient light diffusion. Where the light source is a plurality of LEDs, known for being small point sources of light, the panel width may be less than a quarter of an inch.

A reflective coating 200 is applied to the rear planar surface 102 of the light diffusing panel 100, redirecting light toward the front planar surface 101. Reflective coating 200 is preferably white or light colored to provide additional diffusion to the reflected light, although a mirrored or other surface capable of reflecting light may also serve the function of reflecting the light toward front planar surface 101.

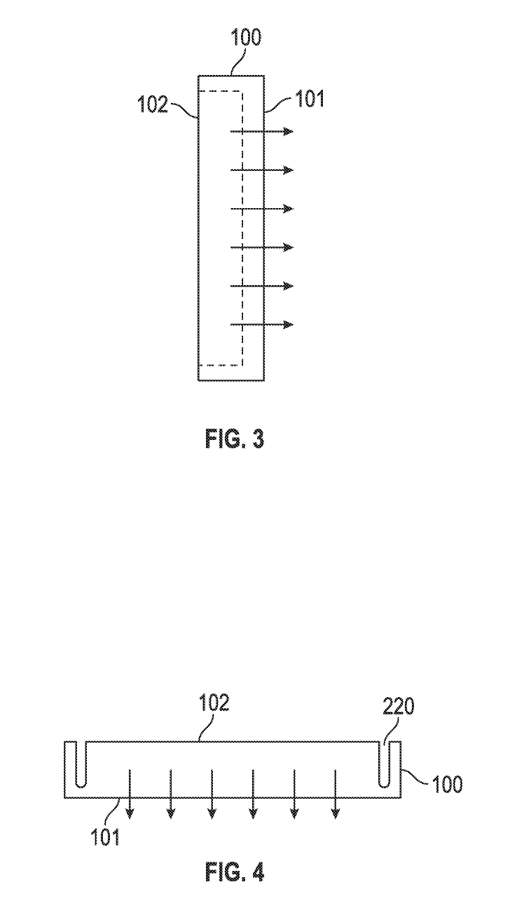

One embodiment of the invention provides light sources 400 along at least one edge of the light diffusing panel. In a preferred embodiment, at least one channel 220 at or near an edge of light diffusing panel 100 may be provided for placement of light sources 400, the light sources 400 being LEDs. For the light diffusing module of the present invention, channel 220 with LED light sources 400 is provided as part of light diffusing panel 100. In FIG. 3, channel 220 is shown with a dashed line, being visible through transparent light diffusing panel 100. In a preferred embodiment, LED light sources 400 would be sealed within channel 220, preventing the entry of water or dirt from coming into channel 220, and potentially interfering with the operation of LED light sources 400.

For light diffusing panels with larger surfaces, the light sources may be placed along additional or all edges of light diffusing panel 100, or may be placed within additional channels at locations remote from edges of light diffusing panel 100. For efficient operation, the width of the light sources is preferably no wider than the width of light diffusing panel 100, namely the distance between front planar surface 101 and rear planar surface 102 of light diffusing panel 100.

LEDs are preferred for use as light sources as LEDs draw lower power than incandescent or fluorescent light sources. With the lower power requirement, LED light sources can be used with solar power and have a longer life span on battery power. LEDs are often small point sources, allowing for use in small locations. LEDs can be used in a variety of temperature ranges, making them more suited for outdoor applications.

With an edge-lit light diffusing panel, light emanating from the LEDs is spread through the panel by internal reflection. Disruptions formed on or in one surface of the panel scatter the LED light, re-directing the light to emit through the surface of the panel. In a preferred embodiment of the present invention, the linear disruptions (110, 120) in the panel surface (front planar surface 101) are laser-etched into the surface of the panel, as laser etching provides an accurate and consistent surface disruption for the LED light scattering function. Alternate etching techniques may be used, where such alternate etching techniques produce consistent surface disruptions.

It is preferred that the linear disruptions 110 be in a parallel arrangement to other linear disruptions 110 and of uniform spacing. Similarly, it is preferred that linear disruptions 120 be in a parallel arrangement to each other and also of uniform spacing. Where linear disruptions 110 and 120 are provided, with linear disruptions 120 being perpendicular to linear disruptions 110, a grid 150 of linear disruptions is formed on front planar surface 101.

The reflected and refracted light emanating from the front planar surface has a uniform brightness. For applications involving long distances from the light source to areas on the front planar surface, the intensity of the light may be increased through the use of additional light sources on other edges of light diffusing panel 100, or within light diffusing panel 100.

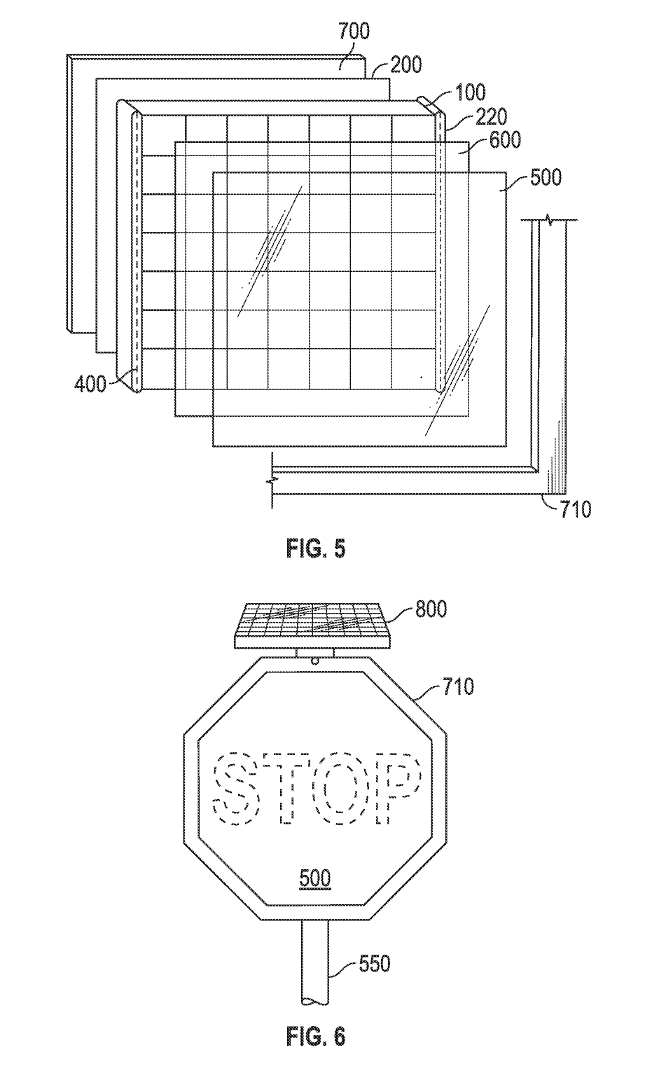

The light diffusing module of the present invention is particularly suited for use in traffic signs and messaging. FIG. 5 shows the assembly of a light diffusing module, and FIG. 6 shows an example representation of a stop sign incorporating the light diffusing module of the present invention. The term “traffic sign” is used herein as representative of any exterior sign or indicator used for control, regulation and information of and for any type of vehicles, including land, water and air vehicles, as well as pedestrians.

In a traffic sign assembly, the light diffusing module is constructed as described above. The traffic sign will add a message panel 500, which is placed in front of front planar surface 101. Message panel 500 is comprised of transparent or translucent material, allowing the diffused light emanating from front planar surface 101 to be visible there-through. As is known in the art, the nature of the material comprising message panel 500 is compliant with government regulations for visible color and size. In operation, the light emanating from front planar surface 101 provides a back lit effect for message panel 500, resulting in greater visibility of message panel 500.

In a preferred embodiment, anti-glare coating 600 is placed between front planar surface 101 and message panel 500. As is known in the traffic sign industry, it may not be permitted to cover message panel 500 with any materials other than those approved for use with traffic signs.

A frame 710 may be placed around the formed light diffusing module, to seal the light diffusing module against the effects of weather, and to support the light diffusing module. As the light diffusing module has no moving parts, and LEDs have long life spans, maintenance of the present invention incorporated into a traffic sign may be limited to replacing the light diffusing module and/or light diffusing panel 100 from a traffic sign with a new light diffusing module or light diffusing panel 100.

The light sources of the light diffusing module of the present invention may be powered by any power source. It is anticipated that for incorporating the present invention in existing traffic sign installations, such as free standing road side signs, the power source to be used will incorporate a rechargeable battery or power storage module and a solar panel for providing a charge to the rechargeable power storage module. In FIG. 6, solar panel 800 is shown mounted on stop sign embodiment. Solar panel 800 is preferably electrically connected to a rechargeable battery which is electrically connected to and powers light sources 400.

Light sources 400 can be powered by any source, as known in the art, but for outdoor implementation of the present invention, a preferred power source is solar energy. Utilizing solar panels or other solar energy capturing devices, the LED light sources can be powered in remote locations, allowing for the use of traffic signs incorporating the light diffusing module of the present invention in any location, regardless of proximity to a utility line or other power source. When using solar energy, an additional battery or other power storage module would be needed for night operation of the light diffusing module.

The light diffusing panel and module of the present invention may be used for any type of traffic or road sign, including warning signs, construction signs, street signs, speed limit signs, traffic control signs, regulatory signs, directional or wayfinding signs, or other signs as are known in the art. The light diffusing panel and module of the present invention may be used in a variety of different types of sign mountings, including poles, overhead mast arm signs, temporary signs, hanging signs, or other mountings as are known in the art.

The light diffusing panel and module of the present invention may be used for billboards, advertising signage or other similar uses as are known in the art or may be developed.

While certain novel features of the present invention have been shown and described, it will be understood that various omissions, substitutions and changes in the forms and details of the device illustrated and in its operation can be made by those skilled in the art without departing from the spirit of the invention.

1. A light diffusion panel comprising:
a panel capable of allowing light to transmit through, the panel having a front planar surface, a rear planar surface and two edges opposite each other across the front and rear planar surfaces;
a first plurality of continuous linear disruptions in the front planar surface, the first plurality of continuous linear disruptions being recesses into the front planar surface, extending between the two edges of the panel;

2. The light diffusion panel of claim 1, where the first plurality of continuous linear disruptions are arranged parallel to each other.

3. The light diffusion panel of claim 1, further comprising:
a second plurality of continuous linear disruptions in the front planar surface, the second plurality of continuous linear disruptions being recesses into the front planar surface and oriented perpendicular to the first plurality of continuous linear disruptions.

4. The light diffusion panel of claim 3, where the second plurality of continuous linear disruptions are arranged parallel to each other.

5. A light diffusion module comprising:
a panel capable of allowing light to transmit through, the panel having a front planar surface, a rear planar surface and two edges opposite each other across the front and rear planar surfaces;
a first plurality of continuous linear disruptions in the front planar surface, the first plurality of continuous linear disruptions being recesses into the front planar surface, extending between the two edges of the panel;
a sheet with a reflective surface adjacent to the rear planar surface of the panel, the reflective surface facing the rear planar surface of the panel;
a plurality of light sources oriented to direct light emitted from the light sources toward at least one edge of the panel;

6. The light diffusion panel of claim 5, where the first plurality of continuous linear disruptions are arranged in a parallel relationship.

7. The light diffusion module of claim 5, further comprising:
a second plurality of continuous linear disruptions in the front planar surface, the second plurality of continuous linear disruptions being recesses into the front planar surface and oriented perpendicular to the first plurality of linear disruptions.

8. The light diffusion panel of claim 7, where the second plurality of continuous linear disruptions are arranged in a parallel relationship.

9. The light diffusion module of claim 5, further comprising:
an anti-glare coating on the front planar surface.

10. The light diffusion module of claim 5, further comprising:
a power source for the light sources.

11. A sign comprising:
a panel capable of allowing light to transmit through, the panel having a front planar surface, a rear planar surface and two edges opposite each other across the front and rear planar surfaces;
a first plurality of continuous linear disruptions in the front planar surface, the first plurality of continuous linear disruptions being recesses into the front planar surface, extending between the two edges of the panel;
a sheet with a reflective surface adjacent to the rear planar surface of the panel, the reflective surface facing the rear planar surface of the panel;
a plurality of light sources oriented to direct light emitted from the light sources toward at least one edge of the panel;
a message panel located adjacent to the front planar surface of the panel, the message panel allowing light to transmit there through, and comprising a message;

12. The light diffusion panel of claim 11, where the first plurality of continuous linear disruptions are arranged in a parallel relationship.

13. The light diffusion panel of claim 20, where the second plurality of continuous linear disruptions are arranged in a parallel relationship.

14. The sign of claim 11, further comprising a power supply.

15. The sign of claim 14, where the power supply comprises a rechargeable battery.

16. The sign of claim 15, where the power supply comprises a solar panel.

17. The sign of claim 11, where the message is comprised of one of the following informational text, informational graphic, or advertising content.

18. The sign of claim 11, further comprising a frame, where the frame supports the panel, sheet, plurality of light sources and message panel.

19. The sign of claim 11, further comprising an antiglare coating, the antiglare coating located in between the front planar surface of the panel and the message panel.

20. The sign of claim 11, further comprising:
a second plurality of continuous linear disruptions in the front planar surface, the second plurality of continuous linear disruptions being recesses into the front planar surface and oriented perpendicular to the first plurality of linear disruptions.
